(19) United States
(12) Patent Application Publication
(10) Pub. No.: US 2012/0005135 A1
(43) Pub. Date: Jan. 5, 2012

(54) RECOGNITION DICTIONARY TRAINING METHOD, SYSTEM, AND PROGRAM

(75) Inventor: Hiroyoshi Miyano, Tokyo (JP)

(73) Assignee: NEC CORPORATION, Tokyo (JP)

(21) Appl. No.: 13/255,614

(22) PCT Filed: Mar. 5, 2010
(86) PCT No.: PCT/JP2010/054159

§ 371 Date: Sep. 9, 2011

(30) Foreign Application Priority Data
Mar. 11, 2009 (JP) 2009-057285

(51) Int. Cl. G06F 15/18

(52) U.S. Cl. 706/12

(57) ABSTRACT

The present invention provides a recognition dictionary training method, a system, and a program for allowing a computer to function as a recognition dictionary training system that does not cause a lowered recognition performance with regard to input vectors other than training data. In a recognition dictionary training system, an initial value setting means 11 initializes each of parameters of a formula derived from parameterization in a framework of a logistic regression with use of a plurality of heavy-tailed distribution functions. In an input means 12, a subset of input vectors to be trained is inputted from a group of input vectors for training data. In a modified parameter calculation means 13, modified values of the parameters are calculated so as to decrease a predetermined evaluation function. In a parameter modification means 14, the parameters are renewed based upon the modified values. The processes from the input means 12 to the parameter modification means 14 are repeated until a termination is determined in a termination determination means 15.

### TECHNICAL FIELD

The present invention relates to a recognition dictionary training method used in pattern recognition or the like, a recognition dictionary training system to which such a recognition dictionary training method is applied, and a program for allowing a computer to function as a recognition dictionary training system.

### BACKGROUND ART

In a conventional recognition method of using, as a recognition result of an input vector, a category of a reference vector that is the closest to the input vector based upon calculation of a distance between a group of reference vectors (also referred to as templates), which is referred to as a recognition dictionary, and the input vector, the recognition accuracy varies depending upon values of the reference vectors. Therefore, for enhancing the recognition accuracy, great importance has been attached to how to set values of reference vectors. Here, a training method called learning vector quantization (LVQ) was proposed by Kohonen and has been known as a method of using a plurality of input vectors as training data and automatically setting values of reference vectors (see Non-Patent Literature 1).

Furthermore, GLVQ has been known as a model in which the stability of computation of the LVQ has been improved so as to facilitate application to practical problems (see Patent Literature 1 and Non-Patent Literature 2).

Moreover, other techniques, such as GRLVQ (see Non-Patent Literature 3) and H2M-LVQ (see Non-Patent Literature 4), have also been developed as further extended training techniques.

Some of the “recognition method of using, as a recognition result of an input vector, a category of a reference vector that is the closest to the input vector based upon calculation of a distance between a group of reference vectors (also referred to as templates), which is referred to as a recognition dictionary, and the input vector” have been described above and are advantageous in that a classification process can be performed at a very high speed. In various types of LVQ techniques as described above, a classification plane used for classification is expressed as a set of segment hyperplanes.

Meanwhile, techniques, such as a support vector machine (SVM) and a logistic regression, have frequently been used for classification in recent years. Those techniques are designed not only to minimize an error of training data, but also to improve the performance with regard to data that have not been trained. For example, the SVM intends to improve the recognition performance with regard to input vectors other than training data by the concept of maximizing the margin (see Non-Patent Literature 5).

In the LVQ, a period of time required for a recognition process increases in proportion to the number of reference vectors. In the SVM, a period of time required for a recognition process increases in proportion to the number of support vectors. The number of support vectors is much larger than the number of reference vectors in the LVQ (see, e.g., Non-Patent Literature 6). Therefore, the SVM suffers from the problem that the recognition speed of the SVM is much slower than that of the LVQ.

Furthermore, the logistic regression is a method of directly estimating the posterior probability. For example, it is assumed that input vectors are denoted by x₁ to x_{N} and that each of the input vectors belongs to either of two classes ω_{c} and ωₑ. The class of the input vector xᵢ is represented by ω(xᵢ). If the input vector xᵢ belongs to the class ωₑ, then yᵢ=1. If the input vector xᵢ belongs to the class ωₑ, then yᵢ=−1.

The posterior probability is expressed by parameters as shown in the following formula Math. 1 (see Non-Patent Literature 7).

P(ωc|x)=1/(1+exp(−wₓx+w₀)) (Math. 1)

The following formula Math. 2 is derived when y is used as in the above formula Math. 1.

P(ω(x)|x)=1/(1+exp(y(−wₓx+w₀)) (Math. 2)

Now the parameters wₓ and w₀ used in the above formula Math. 2 are estimated from training data. Generally, the maximum likelihood estimation is used for this purpose. The likelihood function can be expressed by the following formula Math. 3.

L=ΠᵢP(ω(xᵢ)|xᵢ) (Math. 3)

If S is defined as a value obtained by taking the logarithm of the above formula Math. 3 and reversing its sign, the following formula Math. 4 is obtained.

S=−Σᵢ log P(ω(xᵢ)|xᵢ)=Σᵢs(wₓ*xᵢ+w₀) where s(η)=log(1+exp (η)) (Math. 4)

The above formula Math. 4 is a problem of minimizing S with the parameters wₓ and w₀. In the logistic regression, effects of improving the performance with regard to data that have not been trained can be achieved by a process of weight decay (see Non-Patent Literature 8). Specifically, when S is modified into the following formula Math. 5, it becomes substantially equivalent to an evaluation function used in the SVM as indicated by the following formula Math. 5, for example, as seen in Non-Patent Literature 9.

S=Σᵢs(wₓ*xᵢ+w₀)+C|wₓ|² (Math. 5)

S=Σᵢh(wₓ*xᵢ+w₀)+C|wₓ|² (Math. 6)

Here, h represents a hinge loss function in the above formula Math. 6. The parameter C is a predetermined constant. As is apparent from the aforementioned formula transformation, addition of weight decay to the logistic regression is an optimization problem of an evaluation function, which is similar to the SVM, and can achieve effects of improving the recognition performance with regard to input vectors other than training data.

The aforementioned formulas of the logistic regression are too simplified to generate a complicated classification plane. Therefore, the recognition performance is poorer than the recognition performance of the LVQ, various techniques of the LVQ, and the SVM.

### PRIOR ART

Patent Literature 1: JP-A 09-6745
Non-Patent Literature 1: T. Kohonen: “The Neural Phonetic Typewriter,” IEEE Computer, Vol. 21, No. 3, pp. 11-22.
Non-Patent Literature 2: Atsushi Sato, Keiji Yamada: “A Proposal of Generalized Learning Vector Quantization,” the Institute of Electronics, Information and Communication Engineers Technical Report. NC, Neurocomputing, Vol. 95, No. 346, pp. 87-94.
Non-Patent Literature 3: Barbara Hammer, Thomas Villman: “Generalized Relevance Learning Vector Quantization,” Neural Networks, Vol. 15, pp. 1059-1068.
Non-Patent Literature 4: A. K. Qin, P. N. Suganthan: “Initialization insensitive LVQ algorithm based on cost-function adaptation,” Pattern Recognition, Vol. 38, pp. 773-776.
Non-Patent Literature 5: Richard O. Duda, Peter E. Hart, David G. Stork, Translation supervisor: Morio Onoe: “Pattern Classification,” Shin-Gijutsu Communications, 2001, pp. 256-259.
Non-Patent Literature 6: Toshinori Hosoi, Tetsuaki Suzuki, Atsushi Sato: “Face Detection based on Generalized Learning Vector Quantization,” Technical report of IEICE PRMU, Vol. 102, pp. 47-52.
Non-Patent Literature 7: Christopher M. Bishop: “Neural Networks for Pattern Recognition,” pp. 82-83.
Non-Patent Literature 8: Richard O. Duda, Peter E. Hart, David G. Stork, Translation supervisor: Morio Onoe: “Pattern Classification,” Shin-Gijutsu Communications, 2001, pp. 311-312.
Non-Patent Literature 9: Shai Shalev-Shwartz, Yoram Singer, Nathan Srebro: “Pegasos: Primal Estimated sub-GrAdient SOlver for SVM,” ACM International Conference Proceeding Series; Vol. 227, pp. 807-814.
Non-Patent Literature 10: Ferenc Nagy: “Parameter Estimation of the Cauchy Distribution in Information Theory Approach,” Journal of Universal Computer Science, Vol. 12, No. 9, pp. 1332-1344.
Non-Patent Literature 11: Soren Asmussen: “Applied Probability and Queues,” Springer, pp. 412.
Non-Patent Literature 12: S. Resnick: “On The Foundations of Multivariate Heavy Tail Analysis,” Journal of Applied Probability, vol. 41A, 2004, pp. 191-212.

### DISCLOSURE OF THE INVENTION

### Problem(s) to be Solved by the Invention

A variety of conventional techniques based upon the aforementioned LVQ are advantageous in that a classification can be performed at a very high speed with use of dictionary data after training. However, those techniques do not take care of improvement in recognition performance with regard to input vectors other than training data during a training process and do not permit a curved surface on a classification plane. Therefore, those techniques may impair the recognition performance with regard to input vectors other than training data.

Meanwhile, when the aforementioned SVM is to be used, a high-speed recognition cannot be achieved because formulas cannot be expressed with use of a small number of reference vectors, unlike the LVQ.

Furthermore, when the aforementioned logistic regression is to be used, satisfactory recognition performance cannot be obtained because a complicated classification plane cannot be produced.

Therefore, it is a technical object of the present invention to provide a recognition dictionary training method that trains so as to improve the recognition performance with regard to input vectors other than training data with maintaining characteristics of performing a high-speed classification, a system, and a program for allowing a computer to function as a recognition dictionary training system.

### Means to Solve the Problem

According to one aspect of the present invention, there is provided a method of training a recognition dictionary used for recognizing an input vector to be recognized based upon a plurality of reference vectors in the recognition dictionary and the input vector, which includes a parameterization step of parameterizing each of the plurality of reference vectors with a set of distribution functions having a tail heavier than a normal distribution; and a minimization training step of conducting training so as to minimize a predetermined evaluation function based upon the parameters.

Furthermore, according to another aspect of the present invention, there is provided a system for training a recognition dictionary used for recognizing an input vector to be recognized based upon a plurality of reference vectors in the recognition dictionary and the input vector, which includes: parameterizing means for parameterizing each of the plurality of reference vectors with a set of distribution functions having a tail heavier than a normal distribution; and minimization training means for conducting training so as to minimize a predetermined evaluation function based upon the parameters.

Moreover, according to still another aspect of the present invention, there is provided a recognition dictionary training program for allowing a computer to function to train a recognition dictionary used for recognizing an input vector to be recognized based upon a plurality of reference vectors in the recognition dictionary and the input vector, characterized in that the computer is allowed to function as: parameterizing means for parameterizing each of the plurality of reference vectors with a set of distribution functions having a tail heavier than a normal distribution; and minimization training means for conducting training so as to minimize a predetermined evaluation function based upon the parameters.

### EFFECT(S) OF THE INVENTION

The present invention belongs to a category of a classification technique based upon the aforementioned LVQ. Therefore, it is possible to conduct training such as to improve the recognition performance with regard to input vectors other than training data and to produce a curved surface on a classification plane while characteristics of performing a high-speed classification are maintained. Thus, there can be provided a recognition dictionary training method, a system, and a program that can improve the recognition performance with regard to input vectors other than training data.

### BRIEF DESCRIPTION OF DRAWINGS

FIG. 1 is a block diagram showing a configuration of a recognition dictionary training system according to an embodiment of the present invention.

FIG. 2 is a flow chart showing an operation of the recognition dictionary training system of FIG. 1.

FIG. 3 is a graph showing a simple example of input data and reference vectors in the recognition dictionary training method of FIG. 1.

### BEST MODE FOR CARRYING OUT THE INVENTION

An embodiment of the present invention will be described in detail below with reference to the drawings.

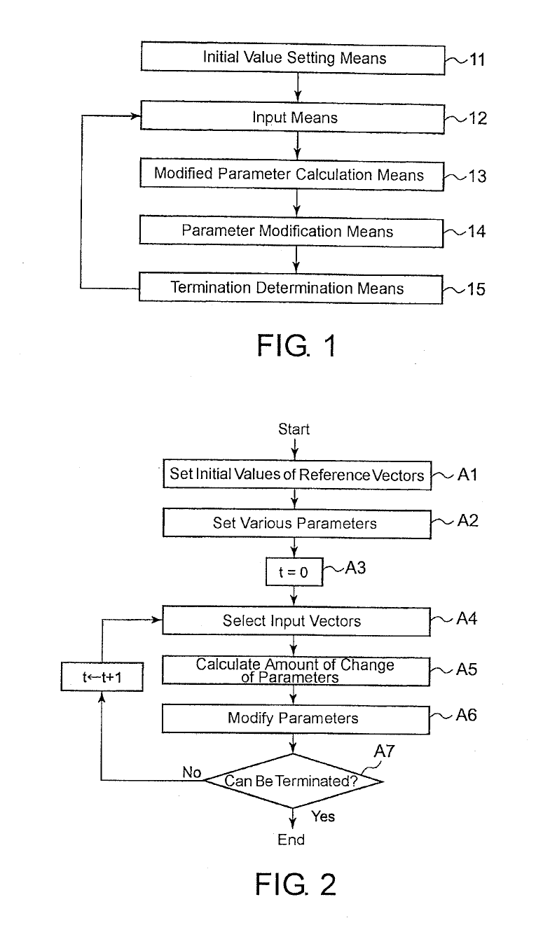

FIG. 1 is a block diagram showing a configuration of a recognition dictionary training system according to an embodiment of the present invention. Referring to FIG. 1, the recognition dictionary training system according to the embodiment of the present invention is configured with use of an information processing apparatus such as a personal computer having a central processing unit (CPU), a memory module (RAM), a mass information storage device such as an HHD or an SDD, an input device such as a mouse or a keyboard, an output device, a display device such as a display, a peripheral circuit of the CPU, interfaces of those devices, and a control circuit for those devices.

The recognition dictionary training system has an initial value setting means 11, an input means 12, a modified parameter calculation means 13, a parameter modification means 14, and a termination determination means 15.

A parameterizing means includes the initial value setting means 11 and parameterizes each of a plurality of reference vectors with a set of distribution functions having a tail heavier than a normal distribution. Furthermore, a minimization training means includes the modified parameter calculation means 13 and the parameter modification means 14 and trains so as to minimize a predetermined evaluation function based upon the parameters.

The initial value setting means 11 sets initial values of positions of reference vectors, initial values of parameters of distribution functions corresponding to the reference vectors, and initial values of parameters of a predetermined evaluation function with reference to a group of N d-dimensional input vectors, which have been prepared for training. At least one reference vector is prepared for each of categories. The number of reference vectors prepared is predetermined. In the following example, M reference vectors are prepared for each of categories. Furthermore, the number of categories is defined by K. Those K categories are expressed by ω₁ to ω_{K}.

The initial values of the positions of the reference vectors can be calculated by, for example, applying a clustering technique such as k-means to the group of the N d-dimensional input vectors prepared for training in each of the categories. Alternatively, the well-known LVQ or various techniques that have been developed from the LVQ, which have been described in Background Art, may be applied.

Predetermined constant values may be used for initial values of parameters of the distribution functions and the evaluation function. Here, a mixed distribution that monotonically decreases in proportional to a distance from each reference vector with the center of the reference vector and “has a tail heavier than a normal distribution” is used for the distribution functions. For example, when the positions of M reference vectors of the category ωₖ are defined by rₖ₁ to r_{kM}, the distribution function is defined as p(x), and a “distribution having a tail heavier than a normal distribution” with the center of r is defined by ƒ(x; r), then p(x) is defined by the following formula Math. 7.

$$p ( x ) = {{max}^{K}}_{k = 1} {A}_{k} f ( {x}^{′} , r = {r}_{k} ) \qquad ( Math . 7 )$$

Meanwhile, in the present invention, a “distribution having a tail heavier than a normal distribution” is called a heavy-tailed distribution in English (see Non-Patent Literature 11). In other words, the distribution hardly decreases at a farther part of a tail when “x→∞.”

Furthermore, the heavy-tailed distribution ƒ(x; r) with the center of r is defined by the following formula Math. 8.

$$\frac{Γ ( \frac{d + v}{2} )}{Γ ( \frac{v}{2} ) {π}^{\frac{d}{2}} det ( S )} \cdot \frac{1}{{( 1 + {( x - r )}^{t} {S}^{- 1} ( x - r ) / v )}^{\frac{d + v}{2}}} \qquad ( Math . 8 )$$

This distribution has a tail heavier than a normal distribution. The parameters of the above distribution function are Aₖ, S, and ν. For example, the parameters may be set such that Ak=1 for all of k, S=(a unit matrix), and ν=1. When ν=1, P coincides with a d-dimensional Cauchy distribution (see Non-Patent Literature 10) as shown by the following formula Math. 9.

$$\frac{Γ ( \frac{d + 1}{2} )}{{π}^{\frac{d + 1}{2}} det ( S )} \cdot \frac{1}{{( 1 + {( x - r )}^{t} {S}^{- 1} ( x - r ) )}^{\frac{d + 1}{2}}} \qquad ( Math . 9 )$$

An isotropic distribution as shown by the following formula Math. 10 may be used in a simplified form.

$$\frac{Γ ( \frac{d + v}{2} ) {a}^{d}}{Γ ( \frac{v}{2} ) {π}^{\frac{d}{2}}} \cdot \frac{1}{{( 1 + {a}^{2} {\vert x - r \vert}^{2} / v )}^{\frac{d + v}{2}}} \qquad ( Math . 10 )$$

The parameters of the above distribution function shown in the formula Math. 10 are Aₖ, a, and ν. For example, the parameters may be set such that Ak=1 for all of k, ξ=1, a=1, and ν=1.

A function from which a process of adding 1 to the term of the denominator is omitted for simplified calculation may be used although integration of the function with respect to x does not become 1 in the strict sense.

A function obtained by raising the above function where d=1 to the dth power may be used as another heavy-tailed distribution.

Furthermore, instead of a maximum value of the K functions, the distribution function p may employ the following formula Math. 11, which uses the sum or the product of the K functions.

$$p ( x ) = {\sum }_{k = 1}^{K} {A}_{k} f ( {x}^{′} , r = {r}_{k} ) \\ p ( x ) = {\prod }_{k = 1}^{K} {A}_{k} f ( {x}^{′} , r = {r}_{k} ) \qquad ( Math . 11 )$$

Meanwhile, when the evaluation function is defined as S, it is expressed by the following formula Math. 12 as with the evaluation function of the logistic regression.

$$S = {\sum }_{i = 1}^{N} s ( {η}_{i} ) + C \sum {( parameter )}^{2} , \\ s ( η ) = log ( 1 + exp ( η ) ) , \\ {η}_{i} = - log \frac{{\sum }_{ω \neq ω ( {x}_{i} )} p ( {x}_{i} \vert ω )}{p ( {x}_{i} \vert ω ( {x}_{i} ) )} \qquad ( Math . 12 )$$

The evaluation function is derived based upon the fact that the posterior probability P(ω(x)|x) can be expressed as in the following formula Math. 13 in accordance with the Bayes' theorem on the assumption that the prior distribution is uniform.

$$\begin{matrix}P ( ω ( x ) \vert x ) = \frac{p ( x \vert ω ( x ) )}{p ( x \vert ω ( x ) ) + {\sum }_{ω \neq ω ( {x}_{i} )} p ( x \vert ω )} \\ = \frac{1}{1 + {\sum }_{ω \neq ω ( {x}_{i} )} p ( x \vert ω ) / p ( x \vert ω ( x ) )}\end{matrix} \qquad ( Math . 13 )$$

Here, in the formula Math. 13, the second term of S is a term obtained by multiplying the sum total of the squares of the parameters used in the distribution function by C. Addition of this term can improve the performance with regard to input vectors other than training data. In the above example, η employs values of the distribution functions of all of the categories. Instead, η may be defined for brevity by the following formula Math. 14.

$${η}_{i} = - log \frac{{max}_{ω \neq ω ( {x}_{i} )} p ( {x}_{i} \vert ω )}{p ( {x}_{i} \vert ω ( {x}_{i} ) )} \qquad ( Math . 14 )$$

Furthermore, a case where an input vector x includes a defect can be treated in the same manner with use of the aforementioned framework. Specifically, it is assumed that an input vector x is expressed by x=(y, z) using a vector y having a non-defective element and a vector z having a defective element. By using the posterior probability P(ω(x)|y) instead of P(ω(x)|x) and calculating η corresponding to the posterior probability P(ω(x)|y) from the above calculation formulas, it is possible to train without any change in process even though the input vector x includes a defect.

The input means 12 is a means for selecting T vectors x₁ to x_{T} from among a group of N input vectors prepared for training. T may have any value from 1 to N. For example, T input vectors x may be selected randomly from N vectors.

The modified parameter calculation means 13 calculates a value of the evaluation function with use of the values of the positions of the M reference vectors and the values of the parameters of the distribution functions and the evaluation function for each of the input vectors x₁ to x_{T} and calculates a value of the evaluation function for those T input vectors. Then the modified parameter calculation means 13 calculates the amount of change in values of the positions of the reference vectors and in values of the parameters of the distribution functions so as to decrease the value of the evaluation function.

For example, the amount of change of the parameters may be calculated by a probabilistic descent method. Specifically, a minus value of a value into which a given value of the evaluation function is differentiated by each of the parameters may be calculated and then multiplied by a predetermined minute coefficient α that decreases as the number of modifications increases, thereby calculating the amount of change of the parameters. Alternatively, α may be a predetermined minute constant.

The parameter modification means 14 modifies the parameter values being currently held with use of the amount of modification of the parameters obtained by the modified parameter calculation means. The modification may be made simply by addition.

A classification can be achieved by calculating a distribution function Aₖp(x; rₘ) corresponding to each of the reference vectors, selecting a reference vector with which the distribution function has a maximum value, i.e., a negative logarithm of the distribution function (−logAₖp(x; rₘ)) has a minimum value, and outputting a category indicated by the selected reference vector. Therefore, as with the conventional LVQ and various extended techniques of the LVQ, high-speed processing can be achieved by training a reduced number of reference vectors. Furthermore, unlike the LVQ and various extended techniques of the LVQ, a calculation technique similar to the logistic regression is used. Therefore, the accuracy with regard to data that have not been trained is not degraded. If Aₖ has a different value depending upon k, the classification plane may have a curved surface. This feature is not seen in the conventional LVQ. This feature can improve the performance of classification.

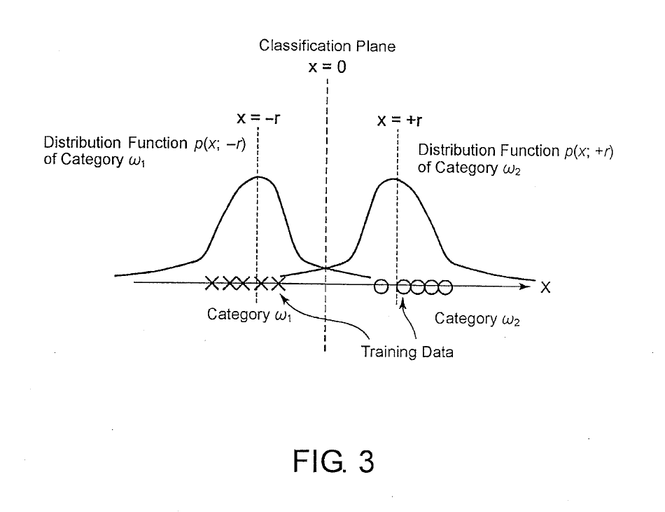

Here, use of a heavy-tailed distribution is essentially needed in order to improve the convergence properties of training. When a plurality of distribution functions are used to form a distribution function, a normal distribution is used as each of the distribution functions, for example, like an RBF model, in most cases. This results from the fact that any distribution function can generally be approximated by superposition of normal distributions unless an outlier is assumed and the fact that calculation is facilitated. With regard to training of the present invention, however, it is not appropriate to use a normal distribution for the distribution functions. This results from the fact that the reference vectors may diverge and the fact that the training becomes unstable. This will be explained with a simple case as shown in FIG. 3.

This example assumes a simple 2-class problem in which d=1 and one reference vector is given for each class. FIG. 3 is a diagram showing a simple example indicating input data and reference vectors in the recognition dictionary training method shown in FIG. 1. As shown in FIG. 3, it is assumed that the classification plane of the class ω₁ and class ω₂ is defined by a distribution of points where x=0. The positions of the reference vectors are set such that x=+r and x=−r.

If the distribution function is a normal distribution, ηᵢ with respect to the input vector x₁ of the category ω₁ can be expressed as shown in the formula Math. 15. Therefore, η increases as r increases. Thus, the evaluation function S has a smaller value.

$${η}_{i} = - log \frac{p ( {x}_{i} \vert {ω}_{2} )}{p ( {x}_{i} \vert {ω}_{1} )} ∝ {( {x}_{i} + r )}^{2} - {( {x}_{i} - r )}^{2} = 4 {rx}_{i} \qquad ( Math . 15 )$$

This means that repulsive divergence forces are applied to reference vectors and that the reference vectors diverge. In contrast, when a heavy-tailed distribution is used, ηᵢ is brought close to 0 as r increases, so that S increases. Therefore, attractive forces are applied to reference vectors. Thus, the reference vectors can be prevented from diverging. In view of the foregoing, stable training and performance improvement with regard to data that have not trained can be achieved only when use of a heavy-tailed distribution as the distribution functions is combined with training of the posterior probability that is similar to the logistic regression training.

The termination determination means 15 determines whether or not to terminate the modification of the parameters. For example, termination may be determined when the amount of modification is smaller than a predetermined value with regard to all of the parameters. Alternatively, termination may be determined when modifications are made a predetermined number of times.

Operation of the recognition dictionary training system according to the embodiment of the present invention will be described in detail below with reference to FIGS. 1 and 2. FIG. 2 is a flow chart showing operation of the recognition dictionary training system of FIG. 1.

Referring to FIG. 2, a group of N input vectors x₁ to x_{N}, which have been prepared for training, are first inputted into the initial value setting means 11. The input vectors for training have been supplied with information on the category to which each of the input vectors belongs.

Clustering such as k-means is conducted such that the group of the N input vectors are divided into M clusters by the categories. The central coordinates of those clusters are set as positions of the reference vectors (Step A1).

Furthermore, initial values of the parameters of the distribution functions and the evaluation function corresponding to a predetermined reference vector are set (Step A2).

Then the value of a variable t, which indicates the number of renewal of the parameters, is initialized into 0 (Step A3).

T vectors x₁ to x_{T} (1≦T≦N) are selected from among a group of N input vectors prepared for training by the input means 12 (Step A4).

For example, those T input vectors x may be selected randomly from N vectors. Alternatively, N vectors may be sorted randomly in advance, and T pieces of data following the last selected piece of data may be selected. In the case where this method is used, if the Nth piece of data is reached before T pieces of data are selected, then data from the first piece may sequentially be selected until T pieces of data are selected.

Next, in the modified parameter calculation means 13, the value of the predetermined evaluation function is calculated from the values of the positions of the M reference vectors and the values of the parameters of the distribution functions for each of the input vectors x₁ to x_{T}, and the sum of those values is calculated. The amount of change in values of the positions of the reference vectors and in values of the parameters of the distribution functions is calculated so as to decrease the sum (Step A5).

Then, in the parameter modification means 14, the values of the parameters being currently held are modified with use of the amount of change of the parameters obtained by the modified parameter calculation means (Step A6). The modification may be made simply by addition.

Thereafter, the termination determination means 15 determines whether or not to terminate the modification of the parameters (Step A7). For example, termination is determined when the amount of modification is smaller than a predetermined value with regard to all of the parameters.

Alternatively, termination may be determined when the value of t becomes larger than a predetermined constant.

Otherwise, a value of t+1 is substituted for t (Step A8).

Then the procedure returns to Step A4.

### EXAMPLE

Next, the present invention will be described along with a further specific example using FIG. 2.

When the aforementioned recognition dictionary training method is carried out, a group of input vectors for training should be prepared in advance. For a specific application, it is assumed that recognition of numeral characters from “0” to “9” is to be performed. For example, an image of a numeral character is taken with a digital camera and stored as a 6-by-7 binary image in a hard disk of a PC. Black pixels of the binary image are defined as 1, whereas white pixels of the binary image are defined as 0. A 35-dimensional vector obtained by scanning the image from the upper left corner along the horizontal direction is used as an input vector. Here, a plurality of input vectors are prepared for each of 10 categories from “0” to “9” and used as a group of input vectors for training. It is assumed that the total number of the collected images of numeral characters is N. The generated input vectors are expressed by x₁ to x_{N}. The input vectors are stored in the hard disk of the PC in advance and read into a memory of the PC to perform the following processes with a CPU of the PC.

First, in Step A1, M 35-dimensional reference vectors, which have the same dimensions as the input vectors, are prepared for each of the categories. The positions of the reference vectors are calculated for each piece of data in 10 categories from “0” to “9” by the k-means clustering.

Then, in Step A2, initial values of the parameters of the distribution functions and the evaluation function are set. In this example, the following formula Math. 16 is used as the distribution function.

$$p ( x ) = {{max}^{K}}_{k = 1} {A}_{k} f ( x , r = {r}_{k} ) \qquad ( Math . 16 )$$

Nevertheless, a distribution ƒ(x; r) having a heavy tail with the center of r employs the following formula Math. 17.

$$\frac{Γ ( \frac{d + v}{2} ) {a}^{d}}{Γ ( \frac{v}{2} ) {π}^{\frac{d}{2}}} \cdot \frac{1}{{( {a}^{2} {\vert x - r \vert}^{2} / v )}^{\frac{d + v}{2}}} \qquad ( Math . 17 )$$

Assuming that the evaluation function is given by the following formula Math. 18, the evaluation function S can be rewritten into the following formula Math. 19 by substituting the numerical formula of the distribution function.

$$\begin{matrix}S = {\sum }_{i = 1}^{N} s ( {η}_{i} ) + C \sum {( parameter )}^{2} , \\ s ( η ) = log ( 1 + exp ( η ) ) , \\ {η}_{i} = - log \frac{{max}_{ω \neq ω ( {x}_{i} )} p ( {x}_{i} \vert ω )}{p ( {x}_{i} \vert ω ( {x}_{i} ) )} & ( Math . 18 ) \\ S = {\sum }_{i = 1}^{N} s ( {η}_{i} ) + C \sum {ξ}^{2} , \\ s ( η ) = log ( 1 + exp ( η ) ) , \\ {η}_{i} = - ξ ( log {\vert {x}_{i} - {r}_{u} \vert}^{2} - log {\vert {x}_{i} - {r}_{v} \vert}^{2} ) & ( Math . 19 )\end{matrix}$$

As is apparent from the formula Math. 19, η can be calculated very simply only with logarithmic calculation and arithmetical operation. Here, rᵤ represents a reference vector having the shortest Euclidean distance among the reference vectors of a category that is the same as the category of the input vector xᵢ, and r_{ν} represents a reference vector having the shortest Euclidean distance among the reference vectors of a category that is different from the category of the input vector xᵢ. Furthermore, C is a predetermined constant, and C=1 in this example.

Furthermore, ξ is a parameter defined by the following formula Math. 20.

$$ξ = \frac{d + v}{2} \qquad ( Math . 20 )$$

Only ξ is a parameter of the distribution function and the evaluation function. In this specific example, Aₖ is set as a fixed parameter, which is not renewed by training. In Step A2, an initial value of ξ is set such that ξ=1.

Then, in Step A3, the value of t, which indicates the number of renewal of the parameters, is initialized into 0.

Subsequently, in Step A4, one vector (T=1) is selected from a group of N input vectors, which have been prepared for training. Specifically, this selection method includes generating a random number that can have a value from 1 to N and selecting an input vector xⱼ corresponding to the random number j.

Thereafter, in Step A5, the amount of change in magnitude of the parameters of the distribution functions is calculated with use of the value of the input vector xⱼ. Specifically, the amount of renewal is calculated as in the formula Math. 21 for the position of the reference vector rₖₘ and the parameter ξ by an approach of the gradient method using a predetermined value α.

$$α = \frac{\partial S}{\partial {r}_{k m}} , \\ α = \frac{\partial S}{\partial ξ} \qquad ( Math . 21 )$$

In this case, α is set so as to have a constant value α=0.01. Then, in Step A6, the values of the parameters are renewed as in the following formula Math. 22.

$${r}_{k m} ← {r}_{k m} - α \frac{\partial S}{\partial {r}_{k m}} \\ ξ ← ξ - α \frac{\partial S}{\partial ξ} \qquad ( Math . 22 )$$

In Step A7, it is determined whether or not to terminate the modification of the parameters.

For example, it is assumed that modifications are made 10 times.

At that time, since t<10, t=t+1. Then the procedure returns to Step A4.

Step A4 to Step A7 are repeated until the number of modifications becomes 10. Then, the process is terminated by the termination determination of Step A7, i.e., by the confirmation process of whether or not to meet t<10.

### INDUSTRIAL APPLICABILITY

As described above, a recognition dictionary training method, a system, and a program for allowing a computer to function as a recognition dictionary training system according to the present invention are applicable to pattern recognition or the like.

This application claims the benefit of priority from Japanese patent application No. 2009-057285, filed on Mar. 11, 2009, the disclosure of which is incorporated herein in its entirety by reference.

### DESCRIPTION OF REFERENCE NUMERALS

11 initial value setting means
12 input means
13 modified parameter calculation means
14 parameter modification means
15 termination determination means

1. A method of training a recognition dictionary used for recognizing an input vector to be recognized based upon a plurality of reference vectors in the recognition dictionary and the input vector, the method comprising:
a parameterization step of parameterizing each of the plurality of reference vectors with a set of distribution functions having a tail heavier than a normal distribution; and
a minimization training step of conducting training so as to minimize a predetermined evaluation function based upon the parameters.

2. The method as recited in claim 1, wherein the parameterization step comprises using one selected from (a) as the heavy-tailed distribution functions, at least one of a t-distribution and a distribution function into which a t-distribution is multi-dimensionally extended and (b) as the evaluation function, an evaluation function calculated in a framework of maximum likelihood estimation of posterior probability.

3. The method as recited in claim 1, wherein the parameterization step comprises using, as the evaluation function, an evaluation function calculated in a framework of maximum likelihood estimation of posterior probability so as to conduct training that allows the input vector to include a defect.

4. The method as recited in claim 1, wherein the minimization training step comprises one of (i) adding to the evaluation function such a term that the evaluation function decreases as the parameters approach 0 and (ii) conducting training that allows a classification plane to have a curved surface.

5. The method as recited in claim 1, wherein the parameterization step comprises an initial value setting step of initializing each of parameters of a formula derived from parameterization in a framework of a logistic regression with use of a plurality of the heavy-tailed distribution functions, and the minimization training step comprises a modified parameter calculation step of calculating modified values of the parameters so as to decrease a predetermined evaluation function and a parameter modification step of renewing the parameters based upon the modified values.

6. The method as recited in claim 5, further comprising an input step of inputting a subset of input vectors to be trained from a group of input vectors for training data, and a termination determination step of repeating, in order named, information processing of the input step, the modified parameter calculation step, and the parameter modification step until a termination is determined.

7. A system for training a recognition dictionary used for recognizing an input vector to be recognized based upon a plurality of reference vectors in the recognition dictionary and the input vector, characterized by comprising:
parameterizing means for parameterizing each of the plurality of reference vectors with a set of distribution functions having a tail heavier than a normal distribution; and minimization training means for conducting training so as to minimize a predetermined evaluation function based upon the parameters.

8. The system as recited in claim 7, wherein the parameterizing means uses one selected from (a) as the heavy-tailed distribution functions, at least one of a t-distribution and a distribution function into which a t-distribution is multi-dimensionally extended and (b) as the evaluation function, an evaluation function calculated in a framework of maximum likelihood estimation of posterior probability.

9. The system as recited in claim 7, wherein the parameterizing means uses, as the evaluation function, an evaluation function calculated in a framework of maximum likelihood estimation of posterior probability so as to conduct training that allows the input vector to include a defect.

10. The system as recited in claim 7, wherein the minimization training step is one of (i) to add to the evaluation function such a term that the evaluation function decreases as the parameters approach 0 and (ii) to conduct training that allows a classification plane to have a curved surface.

11. The system as recited in claim 7, wherein the parameterizing means comprises initial value setting means for initializing each of parameters of a formula derived from parameterization in a framework of a logistic regression with use of a plurality of the heavy-tailed distribution functions, and the minimization training means comprises modified parameter calculation means for calculating modified values of the parameters so as to decrease a predetermined evaluation function and parameter modification means for renewing the parameters based upon the modified values.

12. The system as recited in claim 11, further comprising input means for inputting a subset of input vectors to be trained from a group of input vectors for training data, and termination determination means for repeating, in order named, information processing of the input means, the modified parameter calculation means, and the parameter modification means until a termination is determined.

13. A non-transient recording medium having a recognition dictionary training program capable of reading by computer for allowing a computer to function to train a recognition dictionary used for recognizing an input vector to be recognized based upon a plurality of reference vectors in the recognition dictionary and the input vector, wherein the computer is allowed to function as:
parameterizing means for parameterizing each of the plurality of reference vectors with a set of distribution functions having a tail heavier than a normal distribution; and
minimization training means for conducting training so as to minimize a predetermined evaluation function based upon the parameters.

14. The non-transient recording medium as recited in claim 13, wherein the parameterizing means functions to use one of (a) as the heavy-tailed distribution functions, at least one of a t-distribution and a distribution function into which a t-distribution is multi-dimensionally extended and (b) as the evaluation function, an evaluation function calculated in a framework of maximum likelihood estimation of posterior probability.

15. The non-transient recording medium as recited in claim 13, wherein the parameterizing means functions to use, as the evaluation function, an evaluation function calculated in a framework of maximum likelihood estimation of posterior probability so as to conduct training that allows the input vector to include a defect.

16. The non-transient recording medium as recited in claim 13, wherein the minimization training means functions one of (i) to add to the evaluation function such a term that the evaluation function decreases as the parameters approach 0 and (ii) functions to conduct training that allows a classification plane to have a curved surface.

17. The non-transient recording medium as recited in claim 14, wherein the parameterizing means functions as initial value setting means for initializing each of parameters of a formula derived from parameterization in a framework of a logistic regression with use of a plurality of the heavy-tailed distribution functions, and the minimization training means functions as modified parameter calculation means for calculating modified values of the parameters so as to decrease a predetermined evaluation function and parameter modification means for renewing the parameters based upon the modified values.

18. The non-transient recording medium as recited in claim 17, further allowing the computer to function as input means for inputting a subset of input vectors to be trained from a group of input vectors for training data, and termination determination means for repeating, in order named, information processing of the input means, the modified parameter calculation means, and the parameter modification means until a termination is determined.
